(19) United States
(12) Patent Application Publication
(10) Pub. No.: US 2018/0059308 A1
(43) Pub. Date: Mar. 1, 2018

(54) BACKLIGHT MODULE, METHOD FOR CONTROLLING THE SAME AND DISPLAY DEVICE

(71) Applicant: BOE TECHNOLOGY GROUP CO., LTD., Beijing (CN)

(72) Inventor: Xin Li, Beijing (CN)

(21) Appl. No.: 15/656,023

(22) Filed: Jul. 21, 2017

(30) Foreign Application Priority Data
Aug. 30, 2016 (CN) 201610770339.9

(51) Int. Cl. F21V 8/00

(52) U.S. Cl. CPC G02B 6/0035; G02B 6/0055; G02B 6/0076; G02B 6/0068

(57) ABSTRACT

A backlight module includes a first light guide plate; a second light guide plate located below the first light guide plate; a first backlight source constructed to generate a light incident to the first light guide plate; a second backlight source constructed to generate a light incident to the first light guide plate after passing through the second light guide plate; and a plurality of reflective bars disposed at a surface of the first light guide plate facing the second light guide plate with a gap between two adjacent reflective bars. The backlight module may be switched between the narrow viewing angle mode and the wide viewing angle mode by controlling the first backlight source and/or the second backlight source to be turned off or turned on.

### CROSS-REFERENCE TO RELATED APPLICATION

This application claims the benefit of Chinese Patent Application No. 201610770339.9 filed on Aug. 30, 2016 in the State Intellectual Property Office of China, the whole disclosure of which is incorporated herein by reference.

### BACKGROUND OF THE INVENTION

### Field of the Invention

At least one embodiment of the disclosure relates to the field of display techniques, particularly to a backlight module and a method for controlling the same, and a display device.

### Description of the Related Art

With the development of society and the richness of material conditions, mobile phones, computers, televisions and other types of electronic devices have become more and more close to people's life and work. However, while providing people with a lot of convenience, the electronic devices may cause personal information to be disclosed.

Taking a display screen of the electronic device as an example, the display screen generally has a wide viewing angle, which is a great advantage for public display. However, the information displayed on the display screen at the wide viewing angle is easily leaked, which is unfavorable for secrecy and security of the personal information. In order to protect the security of the personal information, the current display screen is provided with a layer of shutter anti-peeped film on a surface thereof to narrow the viewing angle, thereby realizing the anti-peeped effect.

For the display screen provided with this shutter anti-peeped film, this anti-peeped method may only reduce the viewing angle. If it is desirable to widen the viewing angle, the shutter anti-peeped film of the display screen has to be removed from the surface of the display screen, which results in inconvenient utilization.

### SUMMARY OF THE INVENTION

In order to at least partially overcome at least one of the above issues and other defects existing in the relevant arts, at least one embodiment of the disclosure provide a backlight module and a method for controlling the same and a display device to switch the backlight module between a narrow viewing angle mode and a wide viewing angle mode.

According to embodiments of an aspect of the disclosure, there is provided a backlight module that includes a first light guide plate; a second light guide plate located below the first light guide plate; a first backlight source constructed to generate a light incident to the first light guide plate; a second backlight source constructed to generate a light incident to the first light guide plate after passing through the second light guide plate; and a plurality of reflective bars disposed at a surface of the first light guide plate facing the second light guide plate with a gap between two adjacent reflective bars.

In backlight module according to an embodiment of the disclosure, each reflective bar is embedded into the first light guide plate, and each reflective bar has a surface facing the second light guide plate and being flush with the surface of the first light guide plate facing the second light guide plate.

In backlight module according to an embodiment of the disclosure, each reflective bar is disposed on the surface of the first light guide plate facing the second light guide plate 4 and protrudes from the surface.

In backlight module according to an embodiment of the disclosure, the second light guide plate is provided with a reflective layer on a surface thereof away from the first light guide plate.

In backlight module according to an embodiment of the disclosure, the first light guide plate is in contact with the second light guide plate.

In backlight module according to an embodiment of the disclosure, a gap is formed between the first light guide plate and the second light guide plate.

In backlight module according to an embodiment of the disclosure, at least one optical film layer is disposed between the first light guide plate and the second light guide plate.

In backlight module according to an embodiment of the disclosure, the first backlight source is located on at least one of opposite sides of the first light guide plate; and/or the second backlight source is located on at least one of opposite sides of the second light guide plate.

In backlight module according to an embodiment of the disclosure, the plurality of reflective bars are arranged in an array.

According to embodiments of another aspect of the disclosure, there is provided a display device comprising the backlight module according to any one of the above embodiments, and a display panel located on a light exiting surface of the first light guide plate of the backlight module.

According to embodiments of a further another aspect of the disclosure, there is provided a method for controlling the backlight module as described above comprising: turning off the first backlight source and turning on the second backlight source so that the backlight module is operated in a narrow viewing angle mode; or turning on the first backlight source so that the backlight module is operated in a wide viewing angle mode.

In the method according to an embodiment of the disclosure, the method further comprises turning off the second backlight source when the backlight module is operated in the wide viewing angle mode.

In the method according to an embodiment of the disclosure, the method further comprises turning on the second backlight source when the backlight module is operated in the narrow viewing angle mode.

In the backlight module and the method for controlling the same and the display device, it is possible to switch the backlight module between the narrow viewing angle mode and the wide viewing angle mode by controlling the first backlight source and/or the second backlight source to be turned off or turned on, thereby facilitating utilization of the user.

### BRIEF DESCRIPTION OF THE DRAWINGS

In order to clearly describe the technical solution of embodiments of the disclosure, the accompanying drawings necessary for describing the embodiments or the prior arts are simply illustrated below. Obviously, the accompanying drawings described below are merely some embodiments of the disclosure, and those skilled in the art may arrive at other accompanying drawings based on these drawings without any inventive steps.

FIG. 1 is a schematic partial cross-sectional view of a backlight module according to an embodiment of the disclosure;

FIG. 2 is an operation principle view of the backlight module shown in FIG. 1 in a narrow viewing angle mode;

FIG. 3 is an operation principle view of the backlight module shown in FIG. 1 in a wide viewing angle mode;

FIG. 4 is an operation principle view of the backlight module shown in FIG. 1 in another wide viewing angle mode;

FIG. 5 is a schematic partial cross-sectional view of a backlight module according to another embodiment of the disclosure;

FIG. 6 is a schematic partial cross-sectional view of a backlight module according to a another embodiment of the disclosure;

FIG. 7 is schematic partial cross-sectional view of a backlight module according to a another embodiment of the disclosure;

FIG. 8 is a schematic partial cross-sectional view of a backlight module according to another embodiment of the disclosure;

FIG. 9 is a schematic partial cross-sectional view of a backlight module according to another embodiment of the disclosure;

FIG. 10 is a schematic partial cross-sectional view of a backlight module according to another embodiment of the disclosure; and

FIG. 11 is a flow chart of a method for controlling a backlight module according to an embodiment of the disclosure.

### DETAILED DESCRIPTION OF PREFERRED EMBODIMENTS OF THE INVENTION

Technical solutions of the disclosure will be fully and clearly described with reference to the accompanying drawings. The embodiments as described are merely a part of embodiments of the disclosure, rather than being all embodiments thereof. In addition, in the below detailed description, for ease of explanation, many specific details are set forth to provide a complete understanding of the embodiments of the disclosure. However, one or more embodiments may be carried out without these specific details.

According to the general inventive concept of embodiments of the disclosure, there is provided a backlight module that includes a first light guide plate; a second light guide plate below the first light guide plate; a first backlight source constructed to generate a light incident to the first light guide plate; a second backlight source constructed to generate a light incident to the first light guide plate after passing through the second light guide plate; and a plurality of reflective bars disposed at a surface of the first light guide plate facing the second light guide plate with a gap between two adjacent reflective bars.

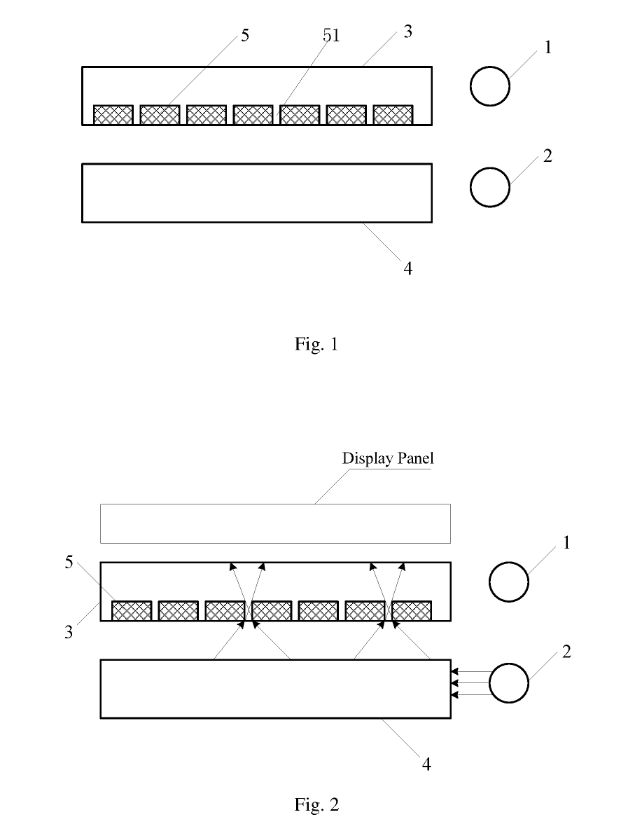

FIG. 1 is a schematic partial section view of a backlight module according to an embodiment of the disclosure. Referring to FIG. 1, embodiments of the disclosure provide a backlight module for a display device comprising a first backlight source 1, a second backlight source 2, a first light guide plate 3, a second light guide plate 4 and a plurality of reflective bars 5. The first light guide plate 3 and the second light guide plate 4 are arranged up and down in a thickness direction of the backlight module, and the second light guide plate 4 is located below the first light guide plate 3. The first backlight source 1 is located at a side of the first light guide plate 3 so that a light generated by the first backlight source 1 is incident to the first light guide plate 3. The second backlight source 2 is located at a side of the second light guide plate 4 so that a light generated by the second backlight source 2 is incident to the first light guide plate 3 after passing through the second light guide plate 4. The plurality of reflective bars 5 are disposed at a surface of the first light guide plate 3 facing the second light guide plate 4. For example, the plurality of reflective bars 5 are arranged in an array with a gap 51 between two adjacent reflective bars 5 to allow the light emitted from the second light guide plate 4 to be incident to an interior of the first light guide plate 3 through the gap 51. Each reflective bar 5 is constructed to reflect the light so that the light incident on the reflective bar 5 is reflected. The backlight module may be disposed below a display panel, and the light is directed to the display panel from the first light guide plate 3 of the backlight module so that the display panel is capable of displaying images.

The backlight module according to embodiments of the disclosure may be operated in a narrow or wide viewing angle mode. Further, the backlight module may be switched between these two operating modes by selectively turning on or turning off the first and second backlight sources.

FIG. 2 is an operation principle view of the backlight module shown in FIG. 1 in the narrow viewing angle mode. Referring to FIG. 2, when the first backlight source 1 is turned off and the second backlight source 2 is turned on, the light emitted from the second backlight source 2 is transmitted to the first light guide plate 3 from a light exiting surface of the second light guide plate 4 facing the first light guide plate 3. Since the first light guide plate 3 is provided with the plurality of reflective bars 5 arranged in the array at the surface thereof facing the second light guide plate 4, only a part of the lights transmitted through the second light guide plate 4 is allowed to pass through the gap 51 between the two adjacent reflective bars 5 and is transmitted to the display panel located above the first light guide plate 3 therethrough. In this way, the backlight module is operated in the narrow viewing angle mode.

FIG. 3 is an operation principle view of the backlight module shown in FIG. 1 in the wide viewing angle mode. Referring to FIG. 3, when the first backlight source 1 is turned on and the second backlight source 2 is turned off, the light emitted from the first backlight source 1 is transmitted to the display panel located above the first light guide plate 3 from a light exiting surface of the first light guide plate 3. In this way, the backlight module is operated in the wide viewing angle mode.

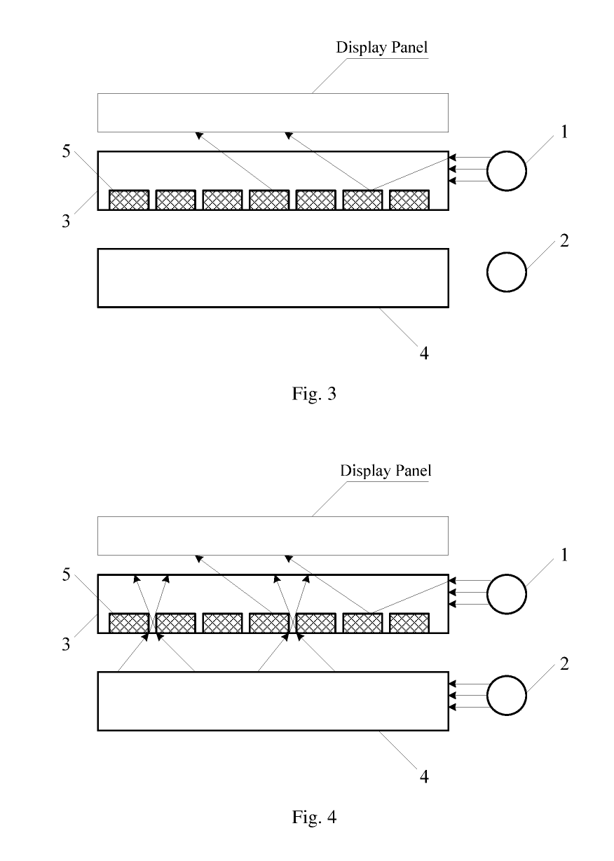

FIG. 4 is an operation principle view of the backlight module shown in FIG. 1 in another wide viewing angle mode. As shown in FIG. 4, on the basis of the wide viewing angle mode shown in FIG. 3, the second backlight source 2 is further turned on. In this way, the light emitted from the second backlight source 2 is transmitted to the first light guide plate 3 located above the second light guide plate 4 from the light exiting the surface of the second light guide plate 4 after passing through the second light guide plate 4. The light, which is emitted from the second backlight source 2 and transmitted through the second light guide plate 4, is partially transmitted through the gap 51 between the two adjacent reflective bars 5 in the first light guide plate 3 and is further transmitted to the display panel located above the first light guide plate 3 therethrough. In this way, the backlight module may be operated in the wide viewing angle mode having higher brightness.

According to the switching process of the operation mode of the backlight module shown in FIGS. 2 to 4, it is possible to switch the backlight module between the narrow viewing angle mode and the wide viewing angle mode only by controlling the first backlight source 1 and/or the second backlight source 2 to be turned off or turned on, thereby facilitating utilization of a user.

In an embodiment of the disclosure, referring to FIG. 1, the first light guide plate 3 may be formed with recesses in the surface thereof close to the second light guide plate 4 so that each of the plurality of reflective bars 5 is embedded into the first light guide plate 3, and a surface of each reflective bar close to the second light guide plate 4 is flush with the surface of the first light guide plate 3 close to the second light guide plate 4.

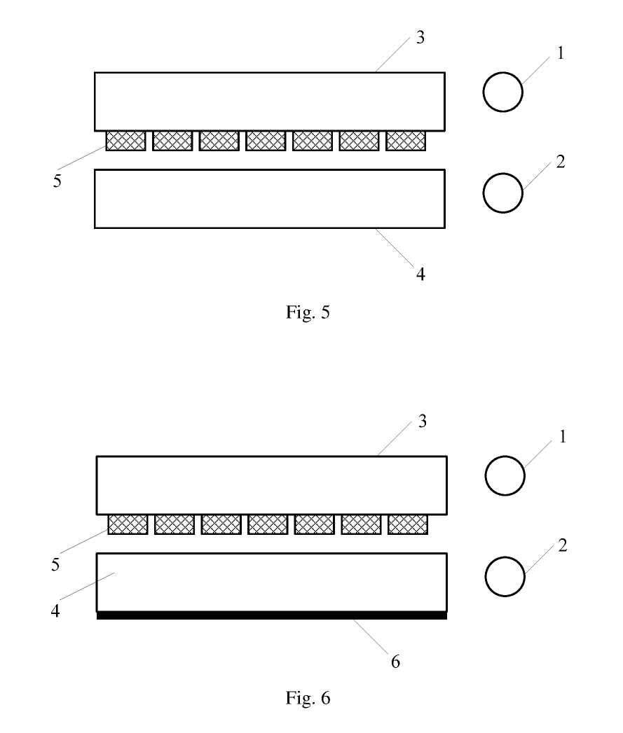

FIG. 5 is a schematic partial cross-sectional view of a backlight module according to another embodiment of the disclosure. Referring to FIG. 5, the backlight module shown in FIG. 5 differs from that shown in FIG. 1 in that each reflective bar 5 is disposed on the surface of the first light guide plate 3 facing the second light guide plate 4 and protrudes from this surface.

Noted that, when being embedded into the first light guide plate 3, each reflective bar 5 has relatively thin thickness which is much thinner than a thickness of the first light guide plate 3. In this way, transmission of the light emitted from the first backlight source 1 through the first light guide plate 3 will not be affected by the thickness of each reflective bar 5.

FIG. 6 is a schematic partial cross-sectional view of a backlight module according to a another embodiment of the disclosure. Referring to FIG. 6, the backlight module shown in FIG. 6 differs from that shown in FIG. 5 in that the second light guide plate 4 is provided with a reflective layer 6 on a surface thereof away from the first light guide plate 3.

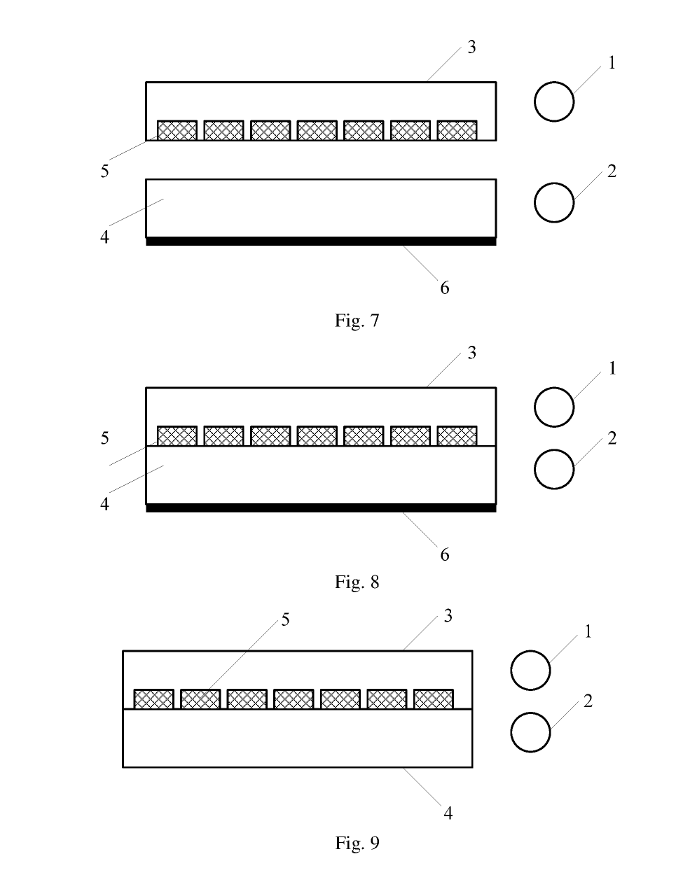

FIG. 7 is a schematic partial cross-sectional view of a backlight module according to yet another embodiment of the disclosure. Referring to FIG. 7, the backlight module shown in FIG. 7 differs from that shown in FIG. 1 in that the second light guide plate 4 is provided with a reflective layer 6 on a surface thereof away from the first light guide plate 3.

In the backlight module of the embodiments shown in FIGS. 6 and 7, since the second light guide plate 4 is provided with the reflective layer 6, the light emitted from the second backlight source 2 may be completely reflected to the first light guide plate 3 by the reflective layer 6.

In the backlight modules of the embodiments shown in FIGS. 1 to 7, there is a gap between the first light guide plate 3 and the second light guide plate 4.

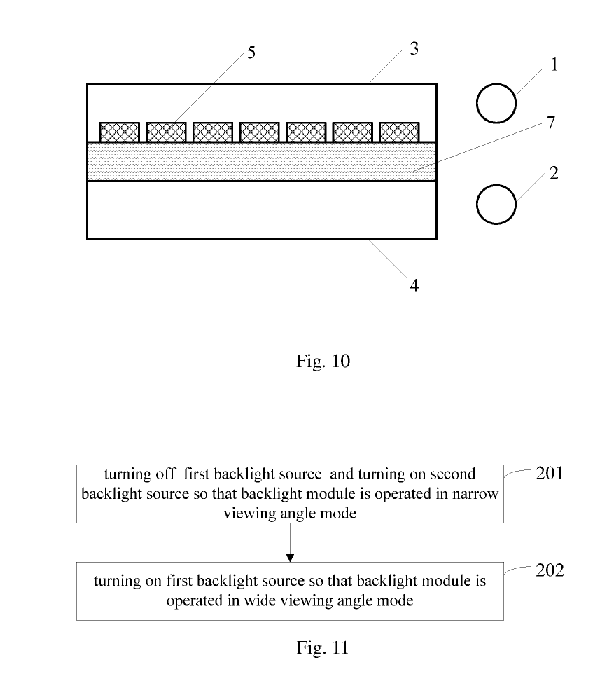

FIG. 8 is a schematic partial cross-sectional view of a backlight module according to another embodiment of the disclosure, and FIG. 9 is a schematic partial cross-sectional view of a backlight module according to a another embodiment of the disclosure. Referring to FIG. 8, the backlight module shown in FIG. 8 differs from that shown in FIG. 7 in that the first light guide plate 3 is in contact with the second light guide plate 4. Referring to FIG. 9, the backlight module shown in FIG. 9 differs from that shown in FIG. 1 in that the first light guide plate 3 is in contact with the second light guide plate 4.

FIG. 10 is a schematic partial cross-sectional view of a backlight module according to another embodiment of the disclosure. Referring to FIG. 10, in the case where there is the gap between the first light guide plate 3 and the second light guide plate 4, the backlight module shown in FIG. 10 differs from that shown in FIG. 1 in that at least one optical film layer 7 is disposed between the first light guide plate 3 and the second light guide plate 4 so as to effectively guide the light from the second light guide plate 4 to the first light guide plate 3. For example, the optical film layer may include, but is not limited to, a diffusion film made of an acrylic resin, an antireflective film, or a polarizing film.

In the embodiments shown in FIGS. 1 to 10, the first backlight source 1 is located at one side of the first light guide plate 3 and the second backlight source 2 is located at one side of the second light guide plate 4. However, the disclosure is not limited thereto. In an alternative embodiment, two first backlight sources 1 may be located at opposite sides of the first light guide plate 3, and/or two second backlight sources 2 may be located at opposite sides of the second light guide plate 4. In another alternative embodiment, the first and second backlight sources 1 and 2 may be disposed inside the first and second light guide plates 3 and 4.

In the backlight module according to embodiments of the disclosure, it is possible to switch the backlight module between the narrow viewing angle mode and the wide viewing angle mode only by controlling the first backlight source and/or the second backlight source to be turned off or turned on, thereby facilitating utilization of the user.

FIG. 11 is a flow chart of a method for controlling a backlight module according to an embodiment of the disclosure. According to embodiments of another aspect of the disclosure, there is provided a method for controlling the backlight module according to any one of the embodiments as described above. Referring to FIG. 11, the method comprises:

Step 201: turning off the first backlight source 1 and turning on the second backlight source 2 so that the backlight module is operated in the narrow viewing angle mode; or

Step 202: turning on the first backlight source 1 so that the backlight module is operated in the wide viewing angle mode.

Referring to FIG. 2, when the first backlight source 1 is turned off and the second backlight source 2 is turned on, the light emitted from the second backlight source 2 is transmitted to the first light guide plate 3 from a light exiting surface of the second light guide plate 4 facing the first light guide plate 3 after passing through the second light guide plate 4. Since the first light guide plate 3 is provided with the plurality of reflective bars 5 arranged in the array on the surface thereof close to the second light guide plate 4, only a part of the light emitted from the second light guide plate 4 is allowed to pass through the gap 51 between the two adjacent reflective bars 5 and is transmitted to the display panel located above the first light guide plate 3 therethrough. In this way, the backlight module is operated in the narrow viewing angle mode.

Referring to FIG. 3, when the first backlight source 1 is turned on and the second backlight source 2 is turned off, the light emitted from the first backlight source 1 is transmitted to the display panel located above the first light guide plate 3 from a light exiting surface of the first light guide plate 3 after passing through the first light guide plate 3. In this way, the backlight module is operated in the wide viewing angle mode.

It should be understood that the second backlight source 2 may be turned off or turned on when the backlight module is operated in the wide viewing angle mode.

Referring to FIG. 4, on the basis of the wide viewing angle mode shown in FIG. 3, the second backlight source 2 is further turned on, and the light emitted from the second backlight source 2 is transmitted to the first light guide plate 3 located above the second light guide plate 4 from the light exiting surface of the second light guide plate 4 after passing through the second light guide plate 4. The light transmitted through the second light guide plate 4 is partially transmitted through the gap between the two adjacent reflective bars 5 in the first light guide plate 3 and is transmitted to the display panel located above the first light guide plate 3 therethrough. In this way, the backlight module may be operated in the wide viewing angle mode of higher brightness.

In the embodiments of the disclosure, when it is desirable for the backlight module to operate in the narrow viewing angle mode, it is only necessary to turn off the first backlight source 1 and turn on the second backlight source 2. When it is desirable for the backlight module to operate in the wide viewing angle mode, it is only necessary to turn on the first backlight source 1. In this way, it is possible to switch the backlight module between the narrow viewing angle mode and the wide viewing angle mode by controlling the first backlight source and/or the second backlight source to be turned off or turned on, thereby facilitating utilization of the user.

Referring to FIGS. 2 and 3, according to a further aspect of the disclosure, there is provided a display device comprising the backlight module as described in any one of the above embodiments and a display panel located on a light exiting surface of the first light guide plate. The light emitted from the backlight module is incident to the display panel from the light exiting surface of the first light guide plate 3 of the backlight module so that the display panel is capable of displaying images.

In the backlight module and the display device according to the embodiments of the disclosure, it is possible to switch the backlight module between the narrow viewing angle mode and the wide viewing angle mode by turning off or turning on the first backlight source and/or the second backlight source, so that the display panel may be operated in the narrow viewing angle mode or the wide viewing angle mode, thereby facilitating utilization of the user.

The above implementations are the preferable embodiments of the disclosure, rather than limiting the disclosure. Any changes, equivalents, modifications made within the sprit and scope of the disclosure should be fallen within the scope of the disclosure.

What is claimed is:

1. A backlight module comprising:
a first light guide plate;
a second light guide plate below the first light guide plate;
a first backlight source configured to generate a light incident to the first light guide plate;
a second backlight source configured to generate a light incident to the first light guide plate after passing through the second light guide plate; and
a plurality of reflective bars disposed at a surface of the first light guide plate facing the second light guide plate with a gap between adjacent ones of the plurality of reflective bars.

2. The backlight module according to claim 1, wherein
each of the plurality of reflective bars are embedded into the first light guide plate; and
wherein each of the plurality of reflective bars has a surface facing the second light guide plate and being flush with the surface of the first light guide plate facing the second light guide plate.

3. The backlight module according to claim 1, wherein each of the plurality of reflective bars is disposed on the surface of the first light guide plate facing the second light guide plate and protrudes from the surface.

4. The backlight module according to claim 1, wherein the second light guide plate is provided with a reflective layer on a surface thereof away from the first light guide plate.

5. The backlight module according to claim 1, wherein the first light guide plate is in contact with the second light guide plate.

6. The backlight module according to claim 1, wherein a gap is formed between the first light guide plate and the second light guide plate.

7. The backlight module according to claim 6, wherein at least one optical film layer is disposed between the first light guide plate and the second light guide plate.

8. The backlight module according to claim 1, wherein
the first backlight source is located on at least one of opposite sides of the first light guide plate; and/or
wherein the second backlight source is located on at least one of opposite sides of the second light guide plate.

9. The backlight module according to claim 1, wherein the plurality of reflective bars are arranged in an array.

10. A display device comprising:
the backlight module according to claim 1; and
a display panel on a light exiting surface of the first light guide plate of the backlight module.

11. A method for controlling the backlight module according to claim 1, comprising:
turning off the first backlight source and turning on the second backlight source so that the backlight module is operated in a narrow viewing angle mode; and
turning on the first backlight source so that the backlight module is operated in a wide viewing angle mode.

12. The method according to claim 11, further comprising:
turning off the second backlight source when the backlight module is operated in the wide viewing angle mode.

13. The method according to claim 11, further comprising:
turning on the second backlight source when the backlight module is operated in the wide viewing angle mode.
